(19) United States
(12) Patent Application Publication
(10) Pub. No.: US 2024/0363002 A1
(43) Pub. Date: Oct. 31, 2024

(54) TRAFFIC INFORMATION ANALYSIS METHOD AND APPARATUS FOR BUILDING TRAFFIC DIGITAL TWIN

(71) Applicant: LAON ROAD INC., Seongnam-si (KR)

(72) Inventors: Sumin PARK, Seoul (KR); Dae Seoung KIM, Seoul (KR)

(21) Appl. No.: 18/639,309

(22) Filed: Apr. 18, 2024

(30) Foreign Application Priority Data
Apr. 27, 2023 (KR) 10-2023-0055719

(51) Int. Cl. G08G 1/01; G06V 20/54; G06V 20/62; G08G 1/08; G08G 1/082

(52) U.S. Cl. CPC G08G 1/0133; G06V 20/54; G06V 20/625; G08G 1/0116; G08G 1/08; G08G 1/082; G06V 2201/08

(57) ABSTRACT

Described herein are a traffic information analysis method and apparatus for building a traffic digital twin. The traffic information analysis method is performed by a traffic information analysis apparatus. The traffic information analysis method includes: collecting traffic information for one or more intersections; setting a time section for each of the intersections by using the traffic information; matching at least one vehicle group for the respective intersections to the time section for each of the intersections; and estimating the movement of the vehicle group.

### CROSS-REFERENCE TO RELATED APPLICATION

This application claims the benefit of Korean Patent Application No. 10-2023-0055719 filed on Apr. 27, 2023, which is hereby incorporated by reference herein in its entirety.

### BACKGROUND

### 1. Technical Field

The embodiments disclosed herein generally relate to a traffic information analysis method and apparatus, and more particularly to a traffic information analysis method and apparatus that estimate the movement of a vehicle group matched to a time section and simulate a non-detection area between intersections.

The embodiments disclosed herein were derived as a result of the research on the task “Development of an Integrated Software Framework (S/W) for NPU-Based Computation of Time-Series Big-Data Deep Learning Applications” of the Next-generation Intelligent Semiconductor Technology Development (Design) Project sponsored by the Korean Ministry of Science and ICT and the Institute of Information & Communications Technology Planning & Evaluation (IITP-00230485).

### 2. Description of the Related Art

Digital twins are a technology that replicates and implements the real world into a digital virtual world. This technology analyzes problems or improvements that may occur in the real world through simulation, finds solutions, and enables rapid responses.

Digital twins are particularly useful in the fields of urban planning and transportation. The development of traffic digital twins for traffic flow and traffic information analysis is in its beginning stage. So far, most traffic digital twins have been built based on intersections where vehicle information can be detected.

Intersection digital twins can represent the locations of vehicles only in detection areas at intersections based on image information from cameras installed at the intersections and detected vehicle information. In other words, there is a limitation in that traffic information cannot be determined in a non-detection area between intersections.

Meanwhile, the above-described background technology corresponds to the technical information that has been possessed by the present inventor in order to contrive the present invention or that has been acquired in the process of contriving the present invention, and can not necessarily be regarded as well-known technology that had been known to the public prior to the filing of the present invention.

For reference, Korean Patent No. 10-2217870 (published on Feb. 19, 2021) discloses an invention regarding a traffic management system using digital twin technology, Korean Patent Application Publication No. 10-2021-0117030 (published on Sep. 28, 2021) discloses an invention regarding a digital twin apparatus and method for autonomous driving virtualization, and Korean Patent No. 10-2248658 (published on May 7, 2021) discloses an invention regarding a traffic management system using artificial intelligence. These related technologies only disclose general information about traffic digital twin technology, but do not provide traffic information analysis technology that can represent various types of traffic information in non-detection areas between intersections, so that it is difficult to implement accurate traffic digital twins.

### SUMMARY

An object of the embodiments disclosed in the present specification is to propose a traffic information analysis method and apparatus that can build a digital twin for an overall area, including a plurality of intersections and a connection road, by allowing for the representation of traffic information in a non-detection area between intersections.

Other objects and advantages of the present invention can be understood from the following description and will be more clearly understood through the embodiments. In addition, it will be readily apparent that the objects and advantages of the present invention can be realized by means and combinations thereof as indicated in the claims.

As a technical solution for accomplishing the above object, according to an embodiment, there is provided a traffic information analysis method for building a traffic digital twin, the traffic information analysis method being performed by a traffic information analysis apparatus, the traffic information analysis method including: collecting traffic information for one or more intersections; setting a time section for each of the intersections by using the traffic information; matching at least one vehicle group for the respective intersections to the time section for each of the intersections based on the time section; and estimating the movement of the vehicle group.

According to another embodiment, there is provided a traffic information analysis apparatus for building a traffic digital twin, the traffic information analysis apparatus including: a communication interface configured to collect traffic information for one or more intersections; and a controller configured to set a time section for each of the intersections by using the traffic information, match at least one vehicle group for the respective intersections to the time section for each of the intersections based on the time section, and estimate the movement of the vehicle group.

According to still another embodiment, there is provided a non-transitory computer-readable storage medium having stored thereon a program that, when executed by a processor, causes the processor to execute the traffic information analysis method.

According to still another embodiment, there is provided a computer program that is executed by a traffic information analysis apparatus and stored in a non-transitory computer-readable storage medium to perform the traffic information analysis method.

### BRIEF DESCRIPTION OF THE DRAWINGS

The accompanying drawings illustrate the embodiments disclosed in the present specification, and serve to help the further understanding of the technical spirit disclosed in the present specification along with specific details for carrying out the invention. The content disclosed in the present specification should not be construed as limited to the items described in the drawings:

FIG. 1 is a diagram illustrating traffic information collected in the detection area of one intersection;

FIG. 2 is a block diagram illustrating the functional configuration of a traffic information analysis apparatus according to an embodiment;

FIG. 3 is a diagram illustrating traffic information in intersection detection areas and estimated traffic information in non-detection areas collected by a traffic information analysis apparatus according to an embodiment;

FIG. 4 is a diagram illustrating the directions of travel at intersections that a traffic information analysis apparatus according to an embodiment takes into consideration when setting a time section for each of the intersections;

FIG. 5 is a diagram illustrating a vehicle movement sequence that a traffic information analysis apparatus according to an embodiment takes into consideration when setting a time section for each intersection;

FIG. 6 is a diagram illustrating vehicle groups for respective intersections, matched to time sections by a traffic information analysis apparatus according to an embodiment, over time;

FIG. 7 is a diagram illustrating changes in intersectional direction signals for nearby intersections connected to a specific intersection by a traffic information analysis apparatus according to an embodiment;

FIG. 8 is a diagram illustrating vehicle groups for respective intersections, matched to time sections according to intersectional direction signals by a traffic information analysis apparatus according to an embodiment, over time;

FIG. 9 is a diagram illustrating the movement of a vehicle group estimated by a traffic information analysis apparatus according to an embodiment; and

FIG. 10 is a flowchart of a traffic information analysis method according to an embodiment.

### DETAILED DESCRIPTION

Various embodiments will be described in detail below with reference to the accompanying drawings. The following embodiments may be modified and practiced in various different forms. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is “directly connected” to the other component but also a case where the one component is “connected to the other component with a third component disposed therebetween.” Furthermore, when one component is described as “including” another component, this does not mean that the one component does not exclude a third component but means that the one component may further include a third component, unless explicitly described to the contrary.

Embodiments will be described in detail below with reference to the accompanying drawings.

Prior to the following description, the meanings of the terms to be used below will be described first.

An intersection is a space where multiple roads intersect or connect. Intersections can be classified into multi-way intersections such as a three-way intersection and a four-way intersection, roundabouts, and multi-level intersections.

A vehicle recognition device is a device that collects vehicle information through a sensor. The vehicle recognition device is also called a vehicle detection system (VDS), and may collect basic data such as traffic volume, occupancy rate, point speed, vehicle type, and still images. Image detection that mainly takes images through traffic closed-circuit television (CCTV) may be used to recognize vehicles. Wireless communication detection that receives identification information in conjunction with a terminal located in a vehicle, such as a Hi-Pass terminal or a user terminal having a traffic-related app installed thereon, may also be utilized. Furthermore, various types of recognition technology may be applied to the vehicle recognition device.

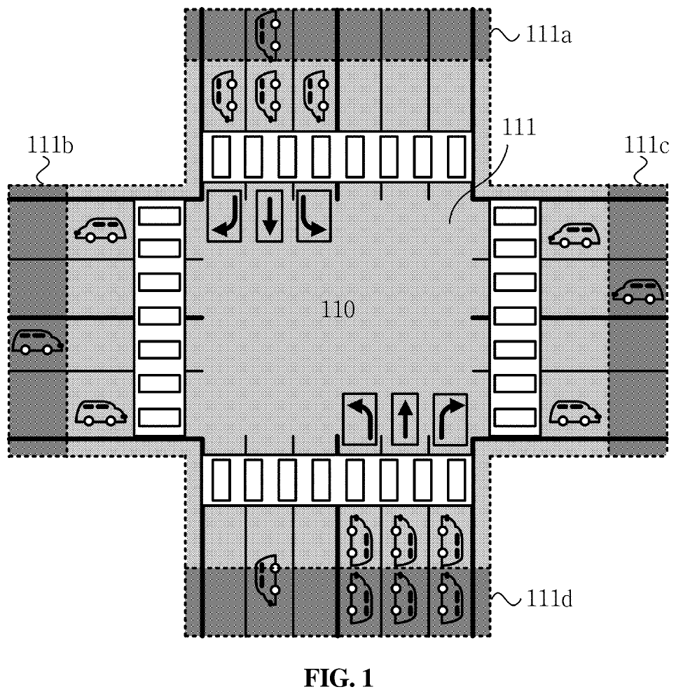

FIG. 1 is a diagram illustrating traffic information collected in the detection area of one intersection.

Referring to FIG. 1, in a screen captured by a vehicle recognition device while viewing one intersection 110, a road area is divided into a detection area 111 and non-detection areas 111a, 111b, 111c, and 111d depending on the installation and angle of the vehicle recognition device.

In the process of building a traffic digital twin, when traffic information regarding the non-detection areas 111a, 111b, 111c, and 111d cannot be obtained or related traffic information cannot be estimated, the real-time locations of vehicles, the travel directions of the vehicles, the total number of vehicles on roads, etc. cannot be represented in the non-detection areas 111a, 111b, 111c, and 111d.

As a vehicle detection technology other than a traffic digital twin, there is a technology that can specify one vehicle appearing in a detection area, determine the locations at which the specified vehicle appears in other detection areas, and track the movement path of the specified vehicle based on the sequence of the determined detection areas. However, the vehicle detection technology for a specific vehicle cannot be directly applied to a traffic digital twin.

A digital twin requires a large amount of data processing. In reality, it is not easy to simultaneously process all non-detection areas while tracking all individual vehicles changing from moment to moment in a detection area and represent them as a traffic digital twin.

Conventional traffic digital twin technology has a problem in that, when a system starts, it is difficult to determine whether a vehicle appearing at a second intersection is a vehicle having appeared at a first intersection or a vehicle having entered halfway. Furthermore, there is a problem in that it is difficult to determine when a vehicle having passed through the first intersection will appear at the second intersection in the state in which there is heavy traffic. Accordingly, it is necessary to consider vehicle speed when implementing a traffic digital twin.

When a non-detection area is a road that connects multiple intersections, even the traffic information of the road of the non-detection area may be estimated depending on how the traffic information of the nearby intersections is utilized.

A traffic information analysis apparatus according to the present embodiment applies a two-step approach that primarily processes data on a vehicle group in a non-detection area by using traffic information in a detection area and secondarily processes data on the movement of individual vehicles belonging to the vehicle group.

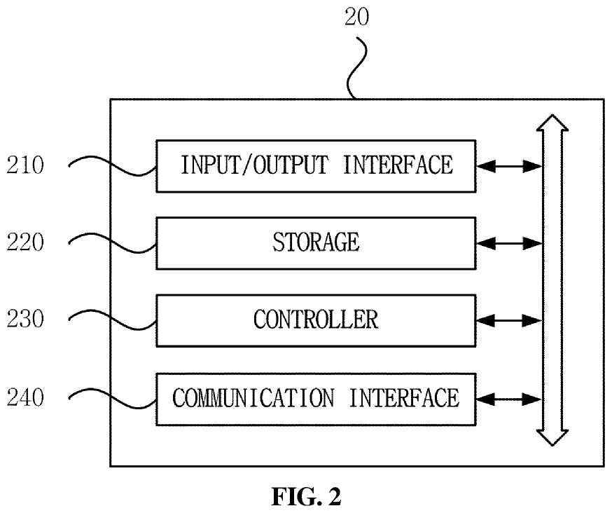

FIG. 2 is a block diagram illustrating the functional configuration of a traffic information analysis apparatus according to an embodiment.

Referring to the configuration of a traffic information analysis apparatus 20 more specifically, it may include an input/output interface 210, storage 220, a controller 230, and a communication interface 240, as shown in FIG. 2.

The input/output interface 210 may include input/output means configured to receive traffic information and output a time section for each intersection set by the controller 230, a vehicle group for each intersection matched by the controller 230, the movement of the vehicle group estimated by the controller 230, and digital twin processing data. The input/output interface 210 may include an input interface configured to receive input, and an output interface configured to display information such as the results of performance of a task or the state of the traffic information analysis apparatus 20. For example, the input/output unit 210 may include an operation panel configured to receive user input, and a display panel configured to display screens.

The input interface may include various types of devices capable of receiving input, such as a keyboard, physical buttons, a touch screen, a camera, and a microphone. The output interface may include a display panel, and a speaker. The input/output interface is not limited thereto, but may include various types of components capable of supporting input or output.

The input/output interface 210 may receive traffic information separately from the communication interface 240, and may obtain some of the information, such as an intersection signal cycle, by extracting it from the items stored in the storage 220.

The input/output interface 210 may output the movement data of the vehicle group estimated by the controller 230 or processing data required for building a digital twin.

Various types of data, such as files and programs, may be installed and stored in the storage 220. The controller 230 may access and use the data stored in the storage 220, or may store new data in the storage 220. Furthermore, the controller 230 may execute a program installed in the storage 220.

The storage 220 may store traffic information, a time section for each intersection, a vehicle group for each intersection, the movement of the vehicle group, and digital twin processing data. The storage 220 may store the intersection signal information of intersection signal devices, the information extracted from public data in an external database, the information obtained through vehicle recognition devices, or a combination thereof.

The storage 220 may store an algorithm used to estimate traffic information required for building a traffic digital twin. This algorithm may include a specific function or a machine learning model such as an artificial neural network required for estimating traffic information.

The controller 230 may control the overall operation of the traffic information analysis apparatus 20 and include a processor such as a CPU, a GPU, and/or the like. The controller 230 may execute a program stored in the storage 220 or calculate data using the algorithm or artificial intelligence model stored in the storage 220. Furthermore, the controller 230 may store processed data back in the storage 220.

The controller 230 may continuously update the intersection signal information of the intersection signal devices, the public data in the external database, and the acquired data of the vehicle recognition devices and store the changed data in the storage 220.

The communication interface 240 may receive traffic information regarding an intersection. The communication interface 240 may transmit the results of the estimated movement of the vehicle group.

The communication interface 240 may perform wired/wireless communication with another device or a network. To this end, the communication interface 240 may include a communication module configured to support at least one of various wired/wireless communication methods. For example, the communication module may be implemented in the form of a chipset.

The wireless communication supported by the communication interface 240 may be, e.g., Wireless Fidelity (Wi-Fi), Wi-Fi Direct, Bluetooth, Ultra-Wide Band (UWB), or Near Field Communication (NFC). Furthermore, the wired communication supported by the communication interface 240 may be, e.g., an LAN cable, Universal Serial Bus (USB), or High Definition Multimedia Interface (HDMI).

The communication interface 240 may enable the traffic information analysis apparatus 20 to communicate with other devices such as the intersection signal devices, the external database, and the vehicle recognition devices.

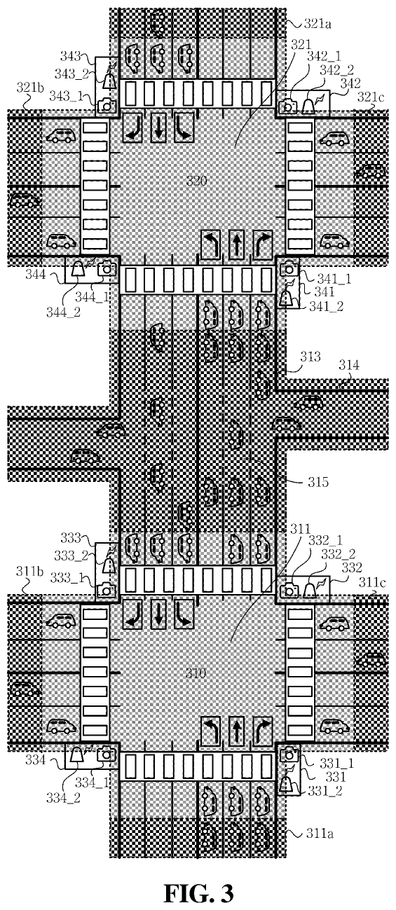

FIG. 3 is a diagram illustrating traffic information in intersection detection areas and estimated traffic information in non-detection areas collected by a traffic information analysis apparatus according to an embodiment.

First, roads and areas constituting a plurality of intersections are assumed and described.

The plurality of intersections include a first intersection 310 and a second intersection 320. The first and second intersections 310 and 320 are connected to each other through a road 313. Furthermore, there may be at least one sub-road 314 branched off from the road 313.

Vehicle recognition devices 331, 332, 333, 334, 341, 342, 343, and 344 may be installed at the intersections 310 and 320 or near the intersections 310 and 320. The vehicle recognition devices 331, 332, 333, 334, 341, 342, 343, and 344 may employ the various detection methods described above. For example, each of the vehicle recognition devices 331, 332, 333, 334, 341, 342, 343, and 344 may include an image detection device 331_1, 332_1, 333_1, 334_1, 341_1, 342_1, 343_1, or 344_1 configured to obtain the image information acquired by capturing the license plate of a vehicle and the image information acquired by capturing the appearance of the vehicle, and a wireless communication detection device 331_2, 332_2, 333_2, 334_2, 341_2, 342_2, 343_2, or 344_2 configured to communicate with a terminal located in the vehicle. The vehicle recognition devices 331, 332, 333, 334, 341, 342, 343, and 344 may obtain image information, wireless information, or a combination thereof.

In FIG. 3, first vehicle recognition devices 331, 332, 333, and 334 configured to detect the first intersection 310 and second vehicle recognition devices 341, 342, 343 and 344 configured to detect the second intersection 320 are shown as pluralities of components. However, they may be implemented as single interconnected components, or may be implemented separately as pluralities of configurations when necessary.

A road area that constitutes the plurality of intersections includes: (i) a detection area 311 for the first intersection 310 by the first vehicle recognition devices 331, 332, 333, and 334 that detect the first intersection 310; (ii) a detection area 321 for the second intersection 320 by the second vehicle recognition devices 341, 342, 343, and 344 that detect the second intersection 320; and (iii) non-detection areas 311a, 311b, 311c, 315, 321a, 321b, and 321c outside the detection ranges of the vehicle recognition devices. A non-detection area 315 located between the first intersection 310 and the second intersection 320 is an area that covers part or all of the road 313, connecting the first and second intersections 310 and 320, and the sub-road 314.

The vehicle recognition devices 331, 332, 333, 334, 341, 342, 343, and 344 installed at or near the intersections may obtain vehicle identification information, vehicle type information, time attribute information, vehicle state information, or a combination thereof.

The vehicle recognition devices 331, 332, 333, 334, 341, 342, 343, and 344 may recognize vehicle identification information and obtain vehicle type information by using the image information acquired by capturing the license plate of each vehicle, the image information acquired by capturing the appearance of the vehicle, the wireless information obtained through communication with a terminal located in the vehicle, or a combination thereof.

The vehicle identification information obtained by the vehicle recognition devices 331, 332, 333, 334, 341, 342, 343, and 344 is unique identification information recognized for the vehicle.

The vehicle type information obtained by the vehicle recognition devices 331, 332, 333, 334, 341, 342, 343, and 344 is vehicle type information that is classified into a plurality of pieces of information according to size and shape. For example, the vehicle type information may be classified into a passenger car, a truck, a special vehicle, a motorcycle, etc.

The time attribute information obtained by the vehicle recognition devices 331, 332, 333, 334, 341, 342, 343, and 344 is attribute information related to time including the speed of movement of each vehicle, the travel time of the vehicle, or a combination thereof.

The vehicle state information obtained by the vehicle recognition devices 331, 332, 333, 334, 341, 342, 343, and 344 includes whether each vehicle is traveling or stopped, the direction of movement of the vehicle, the lane in which the vehicle is located, the queue to which the vehicle belongs, the length of the queue, the number of vehicles in the queue, or a combination thereof.

The vehicle recognition devices 331, 332, 333, 334, 341, 342, 343, and 344 may recognize acquired image information by performing data processing on it, or may extract corresponding information through wireless communication.

Intersection signal devices (not shown) may be located near the intersections. The intersection signal devices may be connected to the intersections and control corresponding intersection signals, and the intersection signal devices may also remotely control the intersection signals. In normal times, the intersection signal cycle is set to be regular. In contrast, when an event occurs, the intersection signal cycle may change irregularly.

The communication interface 240 of the traffic information analysis apparatus 20 communicates with the intersection signal devices, the external database, and the vehicle recognition devices, and collects traffic information for one or more intersections. The traffic information analysis apparatus 20 sets a time section for corresponding to each intersection based on traffic information collected for a plurality of intersections, and estimates the movement of a vehicle group based on the traffic information collected for the plurality of intersections.

The controller 230 of the traffic information analysis apparatus 20 sets a time section for each of the intersections using traffic information, matches at least one vehicle group for the respective intersections to the time section for each of the intersections based on the time section, and estimates the movement of the vehicle group.

The controller 230 sets the time section for each intersection by using the intersection signal information obtained from the intersection signal devices, the information extracted from the public data in an external database, the information obtained through the vehicle recognition devices, or a combination thereof.

The controller 230 may output information about the vehicle group, collected in real time, as a digital twin by using the information extracted from the public data in the external database, the information acquired through the vehicle recognition devices, and/or the combination thereof.

In order to represent the movement of the vehicle group in each non-detection area, the controller 230 needs to set a time section other than the time sections corresponding to the intersections.

As a method of setting a time section, there is a time section division method based on a queue. The presence or absence of a queue is determined through image information, division is made into a case where a queue has not been detected and a case where a queue is taken into consideration, and the cases are separately processed. In the case where a queue has not been detected, a time section in which there are no waiting vehicles is selected, the time required between two intersections is measured, and the measured time is applied as the difference between time sections. In the case where a queue is taken into consideration, a time section in which there are no waiting vehicles other than those detected in a detection area is selected, the time required from an intersection to the detection area is measured, and the measured time is applied as the difference between time sections.

The time section division method based on a queue has difficulty in determining information about a time section in which vehicles are not present in both a case where a queue has not been detected and a case where a queue is taken into consideration, and has a problem in that there occurs a situation in which there is a section in which vehicles are always present. Furthermore, even when an additional time point can be selected, a problem occurs in that the time difference between a first selected time point and a second selected time point is excessively large.

The time section division method based on a queue utilizes image detection, so that there is a problem in that it is difficult to accurately measure the length of a queue through image detection. For example, there may occur cases where a vehicle is located at a long distance from an intersection or a large vehicle obscures the vehicle behind it. The speed information measured at each intersection through image detection has doubt on the reliability of the accuracy thereof, and there is a problem in which the change in vehicle speed after the passage through each intersection is severe.

To overcome these problems, the traffic information analysis apparatus according to the present embodiment may utilize the sectional average speed information of vehicles. When the sectional average speed information between intersections may be obtained, the average travel time between the intersections may be calculated from the average speed information of vehicles regardless of whether there is a queue length. A time section between the intersections may be set using the average travel time. Additionally, using average speed information may overcome the limitations of the queue length and speed information obtained through image detection.

The traffic information analysis apparatus according to the present embodiment sets a time section for each intersection to form a vehicle group between two intersections.

First, a first time section is set using an intersection signal cycle. Next, a second time section may be set using the sectional average speed information or sectional average travel time information of vehicles based on public data on traffic information, or may be set using vehicle travel time information to which vehicle identification and vehicle re-recognition technology is applied.

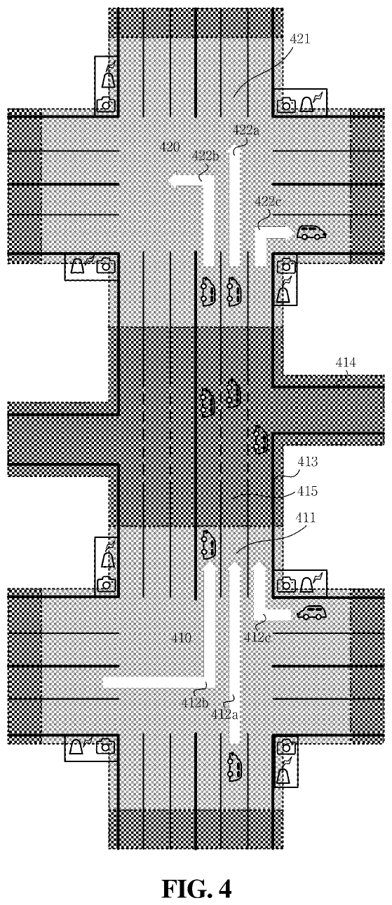

Referring to FIG. 4, the operation of setting a first time section will be described.

FIG. 4 is a diagram illustrating the directions of travel at intersections that a traffic information analysis apparatus according to an embodiment takes into consideration when setting a time section for each of the intersections.

A first intersection 410 and a second intersection 420 are connected to each other through a road 413. The road 413 may include at least one branched sub-road 414. A road area that constitutes the plurality of intersections includes: (i) the detection area 411 of the first intersection 410; (ii) the detection area 421 of the second intersection 420; and (iii) the non-detection area 415 of the road 413.

The paths entering the first intersection 410 may include a straight travel path 412a, a left-turn path 412b, a right-turn path 412c, or a combination thereof.

The paths exiting the second intersection 420 may include a straight travel path 422a, a left-turn path 422b, a right-turn path 422c, or a combination thereof.

In the process of setting the time section for each intersection, the controller 230 may set a first time section corresponding to the first intersection 410 and a second time section corresponding to the second intersection 420 connected to the first intersection 410 through a road. The first time section has a first start time and a first end time, and the second time section has a second start time and a second end time.

In the process of setting the time section for each intersection, the controller 230 may set the first start time and first end time of the first time section based on the intersection signal cycle of the first intersection 410. The controller 230 may extract the intersection signal cycle from the intersection signal information of an intersection signal device. A signal regarding the direction of straight travel may be selected for the intersection signal cycle.

For example, the selected straight travel direction signal is a signal for the direction of travel from the first intersection 410 to the second intersection 420. The first time section may be set to a time section from the start of a straight travel direction signal up to the start of a subsequent straight travel direction signal.

Referring to Tables 1, 2, and 3, the operation of setting the second time section based on public data will be described.

The controller 230 may obtain sectional average speed information, sectional average travel time information, or a combination thereof by using public data in an external database. The sectional average speed information may be converted into the sectional average travel time information based on distance, and the sectional average travel time information may be converted into the sectional average speed information based on distance.

As the public data of an external database, there may be used an open application programming interface (API) provided by the Korean Ministry of Land, Infrastructure and Transport or a navigation app such as Kakao Mobility or TMAP.

Table 1 is a data structure illustrating the output of the API of the Korean Ministry of Land, Infrastructure and Transport.

TABLE 1

```
<item>
  <roadName>Citizen Road</roadName>
  <roadDrcType/>
  <linkNo/>
  <linkId>2090050201</linkId>
  <startNodeId>2090015700</startNodeId>
  <endNodeId>2090015701</endNodeId>
  <speed>27</speed>
  <travelTime>15.88</travelTime>
  <createdDate>20230220113500</createdDate>
</item>
<item>
  <roadName>Citizen Road</roadName>
  <roadDrcType/>
  <linkNo/>
  <linkId>2090050202</linkId>
  <startNodeId>2090015701</startNodeId>
  <endNode Id>20900160500</endNodeId>
  <speed>16</speed>
  <travelTime>64.44</travelTime>
  <createdDate>20230220113500</createdDate>
</item>
```

When the latitude and longitude values of a point of departure and a destination are entered into the open API, the API of the Korean Ministry of Land, Infrastructure and Transport creates a square box using the latitude and longitude values of the point of departure and the destination, divides all roads in the box into links, and provides speed information and travel time information for the links.

Table 2 is a data structure illustrating the output of the API of Kakao Mobility, which is a company or an application engaged in transportation business.

TABLE 2

```
“roads” : [
  {
    “name” : “Citizen Road” ,
    “distance” : 373,
    “duration” : 77,
    “traffic_speed” : 23.0,
    “traffic_state” : 3,
    “vertexes” : [
      .
      .
      .
```

When the latitude and longitude values of a point of departure and a destination are entered into the open API, the API of Kakao Mobility provides distance information, travel time information, speed information, and road congestion information for a path from the point of departure to the destination.

Table 3 is a data structure illustrating the output of the API of TMAP, which is a company or an application engaged in transportation business.

TABLE 3

```
“properties” : {
  “index” : 1,
  “lineIndex” : 0,
  “name” : “Citizen Road” ,
  “description” : “Citizen Road, 374m” ,
  “distance” : 374,
  “time” : 68,
  “roadType” : 5,
  “facilityType” : 0
    .
    .
    .
```

When the latitude and longitude values of a point of departure and a destination are entered into the open API, the API of Kakao Mobility provides distance information and travel time information for a path from the point of departure point to the destination.

In the process of setting a time section for each intersection, the controller 230 may set the second start time and second end time of a second time section based on average travel time information between first and second intersections using public data from an external database.

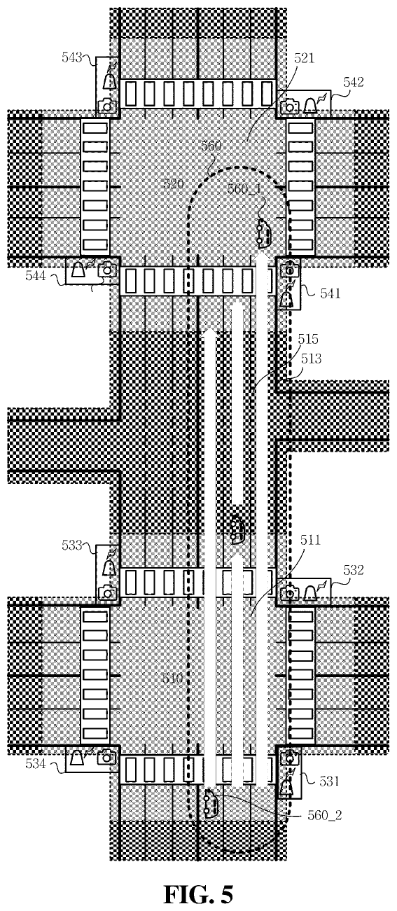

Referring to FIG. 5, the operation of setting the second time section based on the arrival times of a plurality of vehicles will be described.

FIG. 5 is a diagram illustrating a vehicle movement sequence that a traffic information analysis apparatus according to an embodiment takes into consideration when setting a time section for each intersection.

A first intersection 510 and a second intersection 520 are connected to each other through a road 513. A road area that constitutes the plurality of intersections includes: (i) a detection area 511 for the first intersection 510 by first vehicle recognition devices 531, 532, 533, and 534 that detect the first intersection 510; (ii) a detection area 521 for the second intersection 520 by second vehicle recognition devices 541, 542, 543, and 544 that detect the second intersection 320; and (iii) a non-detection area 515 outside the detection ranges of the vehicle recognition devices.

In the process of setting a time section for each intersection, the controller 230 may select a first vehicle and a second vehicle from among the vehicles 560 belonging to the vehicle group based on their sequence by using the vehicle recognition devices. For example, license plate recognition technology may be applied to a vehicle traveling straight, and re-identification technology may be applied to a vehicle turning left or traveling straight. Vehicle license plate recognition and re-identification (Re-ID) may be performed by vehicle recognition devices 531, 532, 533, 534, 541, 542, 543, and 544.

The second start time of a second time section may be set based on the arrival time of the first vehicle, and the second end time of the second time section may be set based on the arrival time of the second vehicle.

For example, the arrival time of the vehicle 560_1, which arrived first at the second intersection 520 from among the vehicles that left the first intersection 510 in the first time section, may be set as the second start time of the second time section. The arrival time of the vehicle 560_2, which arrived last at the second intersection 520 from among the vehicles that left the first intersection 510 in the first time section, may be set as the second end time of the second time section.

The traffic information analysis apparatus 20 may form a vehicle group by setting time sections of two intersections.

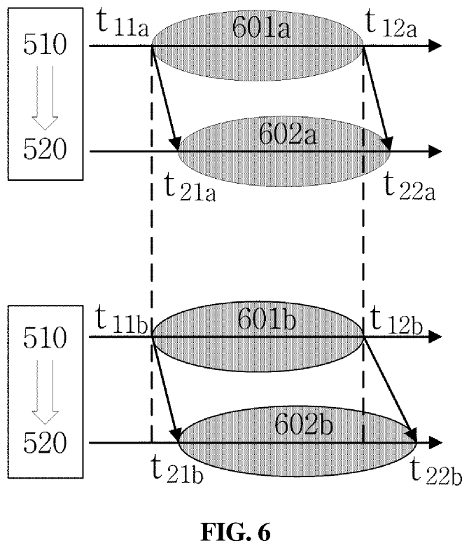

FIG. 6 is a diagram illustrating vehicle groups for respective intersections, matched to time sections by a traffic information analysis apparatus according to an embodiment, over time.

Referring to FIG. 6, the traffic information analysis apparatus 20 may set a first time section [t₁₁ₐ, t₁₂ₐ] corresponding to the first intersection 510 and a second time section [t₂₁ₐ, t₂₂ₐ] corresponding to the second intersection 520, and may set the second time section [t₂₁ₐ, t₂₂ₐ] to [t₁₁ₐ+Δt, t₁₂ₐ+Δt] based on average travel time information Δt. The traffic information analysis apparatus 20 may form vehicle groups 601a and 602a corresponding to the first time section [t₁₁ₐ, t₁₂ₐ] and the second time section [t₂₁ₐ, t₂₂ₐ].

The traffic information analysis apparatus 20 may set a first time section [t_{11b}, t_{12b}] corresponding to the first intersection 510 and a second time section [t_{21b}, t_{22b}] corresponding to the second intersection 520, and may set the second time section [t₂₁ₐ, t₂₂ₐ] to [t_{b1}, t_{b2}] based on the arrival time t_{b1} of the vehicle that arrived first at the second intersection 520 and the arrival time t_{b2} of the vehicle that arrived last at the second intersection 520. The traffic information analysis apparatus 20 may form vehicle groups 601b and 602b corresponding to the first time section [t₁₁ₐ, t₁₂ₐ] and the second time section [t₂₁ₐ, t₂₂ₐ].

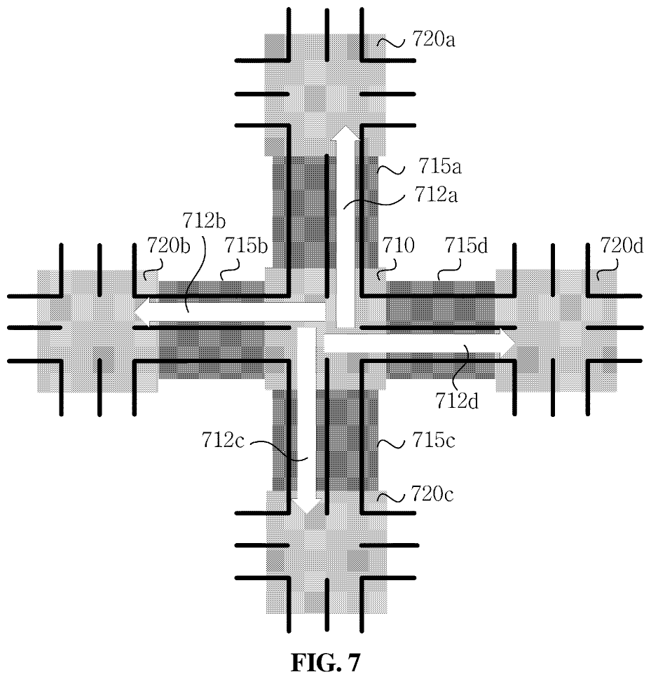

FIG. 7 is a diagram illustrating changes in intersectional direction signals for nearby intersections connected to a specific intersection by a traffic information analysis apparatus according to an embodiment.

A first intersection 710 may be connected to nearby second intersections 720a, 720b, 720c, and 720d.

The traffic information analysis apparatus 20 may set time sections corresponding to the first intersection 710 and the nearby second intersections 720a, 720b, 720c, and 720d. The traffic information analysis apparatus 20 may form a vehicle group moving through the non-detection areas 715a, 715b, 715c, and 715d of the roads connected to the second intersections 720a, 720b, 720c, and 720d according to changes in the straight travel signals 712a, 712b, 712c, and 712d that enable travel in the directions of the second intersections based on the intersection signal cycle of the first intersection 710.

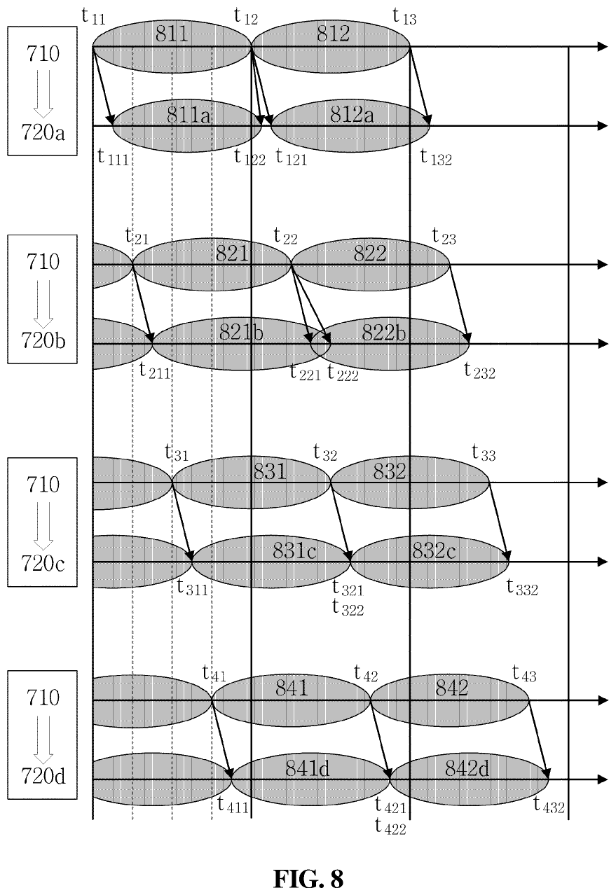

FIG. 8 is a diagram illustrating vehicle groups for respective intersections, matched to time sections according to intersectional direction signals by a traffic information analysis apparatus according to an embodiment, over time.

Referring to FIG. 8, the traffic information analysis apparatus 20 may set a plurality of first time sections [t₁₁, t₁₂], [t₂₁, t₂₂], [t₃₁, t₃₂], and [t₄₁, t₄₂] according to a straight travel signal cycle for each intersection direction at a first intersection 710.

The traffic information analysis apparatus 20 may set a first time section [t₁₁, t₁₂] and a subsequent first time section [t₁₂, t₁₃] corresponding to the first intersection 710 in relation to a first second intersection 720a.

The traffic information analysis apparatus 20 may set a second time section [t₁₁₁, t₁₂₂] and a subsequent second time section [t₁₂₁, t₁₃₂] corresponding to the first second intersection 720a.

The traffic information analysis apparatus 20 may form vehicle groups 811 and 811a corresponding to the first time section [t₁₁, t₁₂] and the second time section [t₁₁₁, t₁₂₂], respectively.

The traffic information analysis apparatus 20 may form subsequent vehicle groups 812 and 812a corresponding to the subsequent first time section [t₁₂, t₁₃] and the subsequent second time section [t₁₂₁, t₁₃₂], respectively.

The end time t₁₂₂ of the second time section and the start time t₁₂₁ of the subsequent second time section may have a time section, and the vehicle group 811a and the subsequent vehicle group 812a according to the first second intersection 720a may be represented as being spaced apart from each other. For example, this may correspond to a scenario in which the last vehicle of a previous group increases its speed at signal change timing, and thus, the distance between the last vehicle of the preceding group and the first vehicle of a subsequent group increases.

When the scenario where the distance between the groups has increased is taken into consideration, the movements of individual vehicles may be represented in the non-detection area 715a connected to the second intersection 720a and the second intersection 720a on a group basis even in a situation where vehicles arriving at the second intersection 720a are separated in terms of time. In other words, a vehicle group matched to each time section is set and one-to-one mapping is performed on individual vehicles belonging to the group, so that a traffic digital twin for the non-detection area 715a connected to the second intersection 720a and the second intersection 720a can be implemented accurately.

The traffic information analysis apparatus 20 may set a first time section [t₂₁, t₂₂] and a subsequent first time section [t₂₂, t₂₃] corresponding to the first intersection 710 in relation to the second intersection 720b.

The traffic information analysis apparatus 20 may set a second time section [t₂₁₁, t₂₂₂] and a subsequent second time section [t₂₂₁, t₂₃₂] corresponding to the second intersection 720b.

The traffic information analysis apparatus 20 may form vehicle groups 821 and 821b corresponding to the first time section [t₂₁, t₂₂] and the second time section [t₂₁₁, t₂₂₂], respectively.

The traffic information analysis apparatus 20 may form subsequent vehicle groups 822 and 822b corresponding to the subsequent first time section [t₂₂, t₂₃] and the subsequent second time section [t₂₂₁, t₂₃₂], respectively.

The second time section and the subsequent second time section may have a partially overlapping time section in connection with the end time t₂₂₂ of the second time section and the start time t₂₂₁ of the subsequent second time section, and the vehicle group 821b and the subsequent vehicle group 822b according to the second intersection 720b may be represented as partially overlapping each other. For example, this may correspond to a scenario in which the first vehicle of a subsequent group is faster than the last vehicle of a previous group, so that the first vehicle overtook the last vehicle while changing lanes.

When this overtaking scenario is taken into consideration, the movements of individual vehicles may be represented in the non-detection area 715b connected to the second intersection 720b and at the second intersection 720b on a group basis even in a situation where the sequences in which the vehicles arrived at the second intersection 720b are mixed with each other. In other words, a vehicle group matched to each time section is set and one-to-one mapping is performed on individual vehicles belonging to the group, so that a traffic digital twin for the non-detection area 715b connected to the second intersection 720b and the second intersection 720b can be implemented accurately.

The traffic information analysis apparatus 20 may set a first time section [t₃₁, t₃₂] and a subsequent first time section [t₃₂, t₃₃] corresponding to the first intersection 710 in relation to the third second intersection 720c.

The traffic information analysis apparatus 20 may set a second time section [t₃₁₁, t₃₂₂] and a subsequent second time section [t₃₂₁, t₃₃₂] corresponding to the third second intersection 720c.

The traffic information analysis apparatus 20 may form vehicle groups 831 and 831a corresponding to the first time section [t₃₁, t₃₂] and the second time section [t₃₁₁, t₃₂₂], respectively.

The traffic information analysis apparatus 20 may form subsequent vehicle groups 832 and 832c corresponding to the subsequent first time section [t₃₂, t₃₃] and the subsequent second time section [t₃₂₁, t₃₃₂], respectively.

The traffic information analysis apparatus 20 may set a first time section [t₄₁, t₄₂] and a subsequent first time section [t₄₂, t₄₃] corresponding to the first intersection 710 in relation to the fourth second intersection 720d.

The traffic information analysis apparatus 20 may set a second time section [t₄₁₁, t₄₂₂] and a subsequent second time section [t₄₂₁, t₄₃₂] corresponding to the fourth second intersection 720a.

The traffic information analysis apparatus 20 may form vehicle groups 841 and 841d corresponding to the first time section [t₄₁, t₄₂] and the second time section [t₄₁₁, t₄₂₂], respectively.

The traffic information analysis apparatus 20 may form subsequent vehicle groups 842 and 842d corresponding to the subsequent first time section [t₄₂, t₄₃] and the subsequent second time section [t₄₂₁, t₄₃₂], respectively.

The traffic information analysis apparatus 20 may represent the movements of the vehicle groups 811, 821, 831, and 841 matching the plurality of first time sections [t₁₁, t₁₂], [t₂₁, t₂₂], [t₃₁, t₃₂], and [t₄₁, t₄₂], respectively, according to a straight travel signal cycle for each intersection direction at the first intersection 710 in accordance with vehicle travel directions based on straight travel signals 712a, 712b, 712c, and 712d with the timing of the straight travel signal cycle taken into consideration. That is, a vehicle group matched to each time section is set and one-to-one mapping is performed on individual vehicles belonging to the group, so that a traffic digital twin for the first intersection 710 and one or more non-detection areas 715a, 715b, 715c, and 715d connected to the first intersection 710 can be implemented accurately.

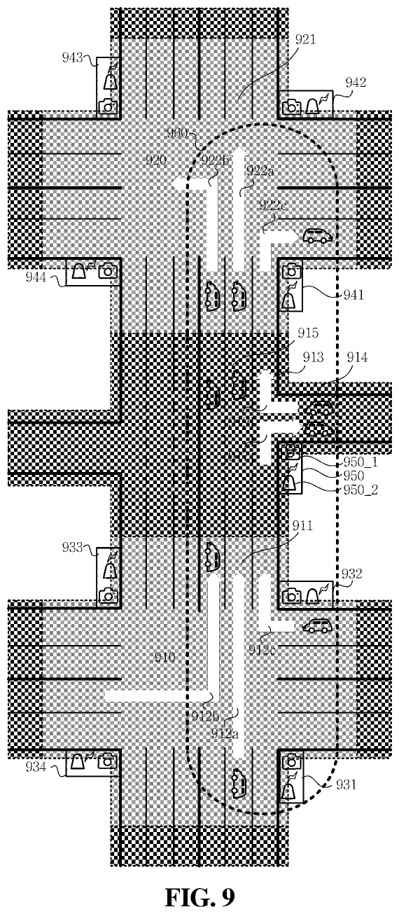

FIG. 9 is a diagram illustrating the movement of a vehicle group estimated by a traffic information analysis apparatus according to an embodiment.

A first intersection 910 and a second intersection 920 are connected to each other through a road 913. The road 913 may include at least one branched sub-road 914.

The road area that constitutes the plurality of intersections includes: (i) a detection area 911 for the first intersection 910 by first vehicle recognition devices 931, 932, 933, and 934 that detect the first intersection 910; (ii) a detection area 921 for the second intersection 920 by second vehicle recognition devices 941, 942, 943, and 944 that detect the second intersection 920; and (iii) an non-detection area 915 outside the detection ranges of the vehicle recognition devices.

In the process of estimating the movement of the vehicle group, the controller 230 may analyze the movement of a vehicle group 960 obtained in the detection area of the intersection, and may simulate the movement of the vehicle group in the non-detection area 915 outside the detection areas 911 and 921.

In the process of estimating the movement of the vehicle group 960, the controller 230 may output information about the vehicle group collected in real time as a digital twin by using the information extracted from public data in an external database, the information obtained through the vehicle recognition devices, or a combination thereof.

The controller 230 utilizes one or both of (i) average speed information and travel time information based on public data, and (ii) vehicle information in the detection area (e.g., vehicle location and lane at each point in time, the length of a queue, the number of vehicles in the queue, and/or the like). The controller 230 may represent not only passing vehicle information but also locations, lanes, the length of a queue, speeds, and travel times in the non-detection area 915.

In the process of estimating the movement of the vehicle group, the controller 230 may estimate movement for each vehicle type, movement for each direction of movement, movement for each vehicle, or a combination thereof by mapping vehicle identification information, vehicle type information, time attribute information, vehicle state information, or a combination thereof to the vehicle group by using the vehicle recognition devices. In other words, the individual vehicles may be mapped to the vehicle group in a one-to-one manner, vehicle types may be recognized and mapping may be performed according to the vehicle type, or mapping may be performed according to the movement type such as straight travel, a left turn or a right turn, or the movement lane.

The control unit 230 may implement a traffic digital twin by simply forming a vehicle group in such a manner as to match the vehicle group to a time section, and may also implement a traffic digital twin by mapping individual vehicles to the vehicle group in a one-to-one manner. The controller 230 may control the representation level of the traffic digital twin to a group representation level, a vehicle type representation level, or an individual vehicle representation level as needed by adjusting representation weight within a predetermined range and output it.

In the process of estimating the movement of the vehicle group, the controller 230 may adjust time attribute information based on vehicle state information, and may adjust vehicle state information based on time attribute information. For example, direction estimation or time estimation may be performed by taking into consideration a change in the length of a queue or speed depending on the movement type or movement lane.

In the process of estimating the movement of the vehicle group, the controller 230 may estimate traffic information corresponding to an entry path, an exit path, or a combination thereof through the at least one sub-road 914 branched off from the road 913 based on the traffic information of the first intersection 910 and the traffic information of the second intersection 920.

The controller 230 may estimate incoming/outgoing vehicles in an open area in the middle of the road by using incoming/outgoing vehicles at each of the intersections.

The total number of vehicles Vₜ₁ having entered the first intersection during the first time section is the sum of the number of vehicles traveling on a straight travel path 912a, the number of vehicles traveling on a left-turn path 912b, and the number of vehicles traveling on a right-turn path 912c.

The total number of vehicles Vₜ₂ having exited the second intersection during the second time section is the sum of the number of vehicles traveling on a straight travel path 922a, the number of vehicles traveling on a left-turn path 922b, and the number of vehicles traveling on a right-turn path 922c.

The controller 230 may utilize the result of comparing the magnitude between the total number of vehicles Vₜ₁ having entered the first intersection during the first time section and the total number of vehicles Vₜ₂ having exited the second intersection during the second time section when estimating the number of vehicles having entered (919)/exited (917) a sub-road 914.

When the total number of vehicles Vₜ₁ having entered the first intersection during the first time section is larger than the total number of vehicles Vₜ₂ having exited the second intersection during the second time section, the controller 230 may estimate the number of vehicles having exited through the sub-road 914 to be a value obtained by subtracting the total number of vehicles Vₜ₂ having exited the second intersection during the second time section from the total number of vehicles Vₜ₁ having entered the first intersection during the first time section. The estimated number of vehicles having exited may be represented in a non-detection area for the sub-road 914.

When the total number of vehicles Vₜ₁ having entered the first intersection during the first time section is smaller than the total number of vehicles Vₜ₂ having exited the second intersection during the second time section, the controller 230 may estimate the number of vehicles having entered through the sub-road 914 to be a value obtained by subtracting the total number of vehicles Vₜ₁ having entered the first intersection during the first time section from the total number of vehicles Vₜ₂ having exited the second intersection during the second time section. The estimated number of vehicles having entered may be represented in the non-detection area for the sub-road 914.

When the total number of vehicles Vₜ₁ having entered the first intersection during the first time section is equal to the total number of vehicles Vₜ₂ having exited the second intersection during the second time section, the controller 230 may estimate the number of vehicles having entered to be equal to the number of vehicles having exited. When the relative number of vehicles having entered/exited rather than the absolute value thereof is taken into consideration, the fact that there are no traveling vehicles may be represented in the non-detection area for the sub-road 914.

In the process of estimating the movement of a vehicle group, the controller 230 may correct the movement of the vehicle group by using traffic information obtained through a vehicle recognition device 950 installed on the road 913 between the first intersection and the second intersection.

The vehicle recognition device 950 installed on the road 913 between the intersections may include an image detection device 950_1 configured to obtain the image information acquired by capturing the license plate of a vehicle and the image information acquired by capturing the appearance of the vehicle, and may include a wireless communication detection device 950_2 configured to communicate with the terminal located in the vehicle. The vehicle recognition device 950 may acquire image information, wireless information, or a combination thereof.

The controller 230 may correct the movement of a vehicle group or individual vehicles located on the road 913 between the intersections based on the traffic information obtained through the vehicle recognition device 950, and may correct the movement of a vehicle group or individual vehicles located on the sub-road 914.

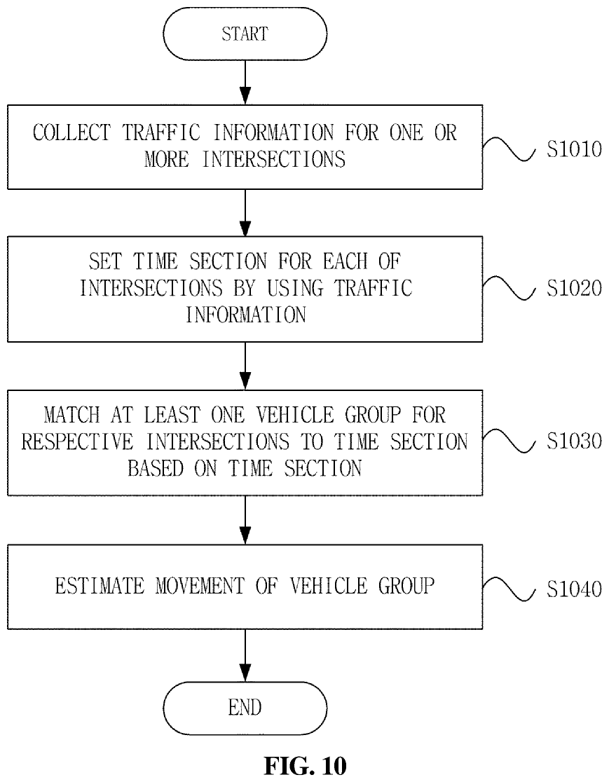

FIG. 10 is a flowchart of a traffic information analysis method according to an embodiment.

The traffic information analysis method according to the embodiment shown in FIG. 10 includes steps that are processed in a time-series manner by the traffic information analysis apparatus 20 shown in FIG. 2. Accordingly, the descriptions that are omitted below but have been given above in conjunction with the traffic information analysis apparatus 20 shown in FIG. 2 may also be applied to the traffic information analysis method according to the embodiment shown in FIG. 10.

Referring to FIG. 10, in step S1010, the traffic information analysis apparatus 20 collects traffic information for one or more intersections.

In step S1020, the traffic information analysis apparatus 20 sets a time section for each of the intersections by using the traffic information.

In step S1030, the traffic information analysis apparatus 20 matches at least one vehicle group for the respective intersections to the time section for each of the intersections based on the time section.

In step S1040, the traffic information analysis apparatus 20 estimates the movement of the vehicle group.

In step S1010 of collecting traffic information, sectional average speed information, sectional average travel time information, or a combination thereof may be obtained using public data from an external database.

In step S1010 of collecting traffic information, vehicle identification information, vehicle type information, time attribute information, vehicle state information, or a combination thereof may be obtained using one or more vehicle recognition devices installed at or near the intersections.

Each of the vehicle recognition devices recognizes vehicle identification information and also obtains vehicle type information by using the image information acquired by capturing the license plate of each vehicle, the image information acquired by capturing the appearance of the vehicle, the wireless information obtained through communication with a terminal located in the vehicle, or a combination thereof.

The vehicle identification information is unique identification information recognized for a vehicle, and the time attribute information is attribute information related to time including the speed of movement of the vehicle, the travel time of the vehicle, or a combination thereof. The vehicle state information is movement state information including whether the vehicle is traveling or stopped, the direction of movement of the vehicle, the lane in which the vehicle is located, the queue to which the vehicle belongs, the length of the queue, the number of vehicles in the queue, or a combination thereof.

In step S1020 of setting a time section for each of the intersections, a first time section corresponding to a first intersection may be set, and a second time section corresponding to a second intersection connected to the first intersection through a road may be set. In this case, the first time section has a first start time and a first end time, and the second time section has a second start time and a second end time.

In step S1020 of setting a time section for each of the intersections, the first start time and first end time of the first time section may be set based on the traffic signal cycle of the first intersection.

In step S1020 of setting a time section for each of the intersections, the second start time and second end time of the second time section may be set based on sectional average travel time information between the first intersection and the second intersection using public data from an external database.

In step S1020 of setting a time section for each of the intersections, a first vehicle and a second vehicle may be selected from among vehicles belonging to the vehicle group based on their sequence by using a vehicle recognition device, the second start time of the second time section may be set based on the arrival time of the first vehicle, and the second end time of the second time section may be set based on the arrival time of the second vehicle.

In step S1040 of estimating the movement of a vehicle group, the movement of the vehicle group obtained in the detection area of the intersections may be analyzed, and the movement of the vehicle group may be simulated in a non-detection area outside the detection area by using the results of the analysis. In other words, the movement of the vehicle group may be represented in the non-detection area.

In step S1040 of estimating the movement of a vehicle group, information about the vehicle group collected in real time may be output as a digital twin by using the information extracted from public data in an external database, the information acquired through the vehicle recognition devices, or a combination thereof.

In step S1040 of estimating the movement of a vehicle group, movement for each vehicle type, movement for each direction of movement, movement for each vehicle, or a combination thereof may be estimated by mapping vehicle identification information, vehicle type information, time attribute information, vehicle state information, or a combination thereof to the vehicle group by using the vehicle recognition devices.

In step S1040 of estimating the movement of a vehicle group, the time attribute information may be adjusted based on the vehicle state information, or the vehicle state information may be adjusted based on the time attribute information.

In step S1040 of estimating the movement of a vehicle group, traffic information corresponding to an entry path, an exit path, or a combination thereof through at least one sub-road branched off from a road may be estimated based on the traffic information of the first intersection and the traffic information of the second intersection.

In step S1040 of estimating the movement of a vehicle group, the movement of the vehicle group may be corrected using the traffic information obtained through the vehicle recognition device installed on a road between the first intersection and the second intersection.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

The functions provided in components and “unit(s)” may be combined into a smaller number of components and “unit(s)” or divided into a larger number of components and “unit(s).”

In addition, components and “unit(s)” may be implemented to run one or more central processing units (CPUs) in a device or secure multimedia card.

The traffic information analysis method according to the embodiment descried through the present specification may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the traffic information analysis method according to the embodiment descried through the present specification may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the traffic information analysis method according to the embodiment descried through the present specification may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

According to any one of the above-described solutions, there may be proposed the traffic information analysis method and apparatus that can set a time section for each intersection by using collected traffic information.

According to any one of the above-described solutions, there may be proposed the traffic information analysis method and apparatus that can match at least one vehicle group for the respective intersections to the time section for each of the intersections based on the time section for each of the intersections.

According to any one of the above-described solutions, there may be proposed the traffic information analysis method and apparatus that can estimate the movement of a vehicle group and simulate various types of traffic information such as the location of each vehicle, the direction of travel of the vehicle, and the number of vehicles on a road in a non-detection area between intersections.

According to any one of the above-described solutions, there may be proposed the traffic information analysis method and apparatus that can improve accuracy when implementing a traffic digital twin by first setting a vehicle group and ultimately mapping detailed vehicles within the vehicle group in a one-to-one manner.

The advantages that can be achieved by the embodiments disclosed herein are not limited to the advantages described above, and other advantages not described above will be clearly understood by those having ordinary skill in the art, to which the embodiments disclosed herein pertain, from the foregoing description.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A traffic information analysis method for building a traffic digital twin, the traffic information analysis method being performed by a traffic information analysis apparatus, the traffic information analysis method comprising:
collecting traffic information for one or more intersections;
setting a time section for each of the intersections by using the traffic information;
matching at least one vehicle group for the respective intersections to the time section for each of the intersections; and
estimating movement of the vehicle group.

2. The traffic information analysis method of claim 1, wherein collecting the traffic information comprises obtaining sectional average speed information, sectional average travel time information, or a combination thereof by using public data from an external database.

3. The traffic information analysis method of claim 1, wherein collecting the traffic information comprises obtaining vehicle identification information, vehicle type information, time attribute information, vehicle state information, or a combination thereof by using vehicle recognition devices installed at or near the intersections.

4. The traffic information analysis method of claim 3, wherein:
the vehicle recognition devices recognize the vehicle identification information and also obtain the vehicle type information by using image information acquired by capturing a license plate of each vehicle, image information acquired by capturing an appearance of the vehicle, wireless information obtained through communication with a terminal located in the vehicle, or a combination thereof;
the vehicle identification information is unique identification information recognized for the vehicle;
the time attribute information is attribute information related to time including movement speed of the vehicle, travel time of the vehicle, or a combination thereof; and
the vehicle state information is movement state information including whether the vehicle is traveling or stopped, a direction of movement of the vehicle, a lane in which the vehicle is located, a queue to which the vehicle belongs, a length of the queue, a number of vehicles in the queue, or a combination thereof.

5. The traffic information analysis method of claim 1, wherein setting the time section for each of the intersections comprises:
setting a first time section corresponding to a first intersection; and
setting a second time section corresponding to a second intersection connected to the first intersection through a road;
wherein the first time section has a first start time and a first end time; and
wherein the second time section has a second start time and a second end time.

6. The traffic information analysis method of claim 5, wherein setting the time section for each of the intersections comprises setting the first start time and first end time of the first time section based on an intersection signal cycle of the first intersection.

7. The traffic information analysis method of claim 5, wherein setting the time section for each of the intersections comprises setting the second start time and second end time of the second time section based on sectional average travel time information between the first and second intersections using public data in an external database.

8. The traffic information analysis method of claim 5, wherein setting the time section for each of the intersections comprises:
selecting a first vehicle and a second vehicle from among the vehicles belonging to the vehicle group based on their sequence by using the vehicle recognition devices;
setting the second start time of the second time section based on an arrival time of the first vehicle; and
setting the second end time of the second time section based on an arrival time of the second vehicle.

9. The traffic information analysis method of claim 1, wherein estimating the movement of the vehicle group comprises:
analyzing movement of the vehicle group obtained in a detection area of the intersections; and
simulating movement of the vehicle group in an non-detection area outside the detection area.

10. The traffic information analysis method of claim 1, wherein estimating the movement of the vehicle group comprises outputting information about the vehicle group, collected in real time, as a digital twin by using information extracted from public data in an external database, information obtained through vehicle recognition devices, or a combination thereof.

11. The traffic information analysis method of claim 3, wherein estimating the movement of the vehicle group comprises estimating movement for each vehicle type, movement for each direction of movement, movement for each vehicle, or a combination thereof by mapping the vehicle identification information, the vehicle type information, the time attribute information, the vehicle state information, or a combination thereof to the vehicle group using the vehicle recognition devices.

12. The traffic information analysis method of claim 3, wherein estimating the movement of the vehicle group comprises adjusting the time attribute information based on the vehicle state information or adjusting the vehicle state information based on the time attribute information.

13. The traffic information analysis method of claim 5, wherein estimating the movement of the vehicle group comprises estimating traffic information corresponding to an entry path, an exit path, or a combination thereof through at least one sub-road branched off from the road based on traffic information of the first intersection and traffic information of the second intersection.

14. The traffic information analysis method of claim 5, wherein estimating the movement of the vehicle group comprises correcting the movement of the vehicle group by using traffic information obtained through a vehicle recognition device installed on the road between the first and second intersections.

15. A traffic information analysis apparatus for building a traffic digital twin, the traffic information analysis apparatus comprising:
a communication interface configured to collect traffic information for one or more intersections; and
a controller configured to set a time section for each of the intersections by using the traffic information, match at least one vehicle group for the respective intersections to the time section for each of the intersections, and estimate movement of the vehicle group.

16. The traffic information analysis apparatus of claim 15, wherein the controller:
sets the time section for each of the intersections by using intersection signal cycle information of an intersection signal device, information extracted from public data in an external database, information obtained through a vehicle recognition device, or a combination thereof; and
outputs information about the vehicle group, collected in real time, as a digital twin by using the information extracted from the public data in the external database, the information obtained through the vehicle recognition device, and/or the combination thereof.

17. A non-transitory computer-readable storage medium having stored thereon a program that, when executed by a processor, causes the processor to execute the traffic information analysis method set forth in claim 1.
